(19) United States
(12) Patent Application Publication
(10) Pub. No.: US 2022/0196031 A1
(43) Pub. Date: Jun. 23, 2022

(54) CENTRIFUGAL COMPRESSOR AND TURBOCHARGER

(71) Applicant: MITSUBISHI HEAVY INDUSTRIES ENGINE & TURBOCHARGER, LTD., Sagamihara-shi, Kanagawa (JP)

(72) Inventors: Kenichiro IWAKIRI, Tokyo (JP); Isao TOMITA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 17/604,611

(22) PCT Filed: May 24, 2019
(86) PCT No.: PCT/JP2019/020574

§ 371 Date: Oct. 18, 2021

(51) Int. Cl. F04D 29/42; F04D 17/10; F04D 29/44

(52) U.S. Cl. CPC F04D 29/4206; F04D 29/441; F04D 17/10

(57) ABSTRACT

In a centrifugal compressor, a diffuser channel includes a curved channel portion that bends toward a front side in an axial direction of an impeller as it goes toward an outer side in a radial direction of the impeller. In a cross-section along a rotation axis of the impeller, when a center line of the diffuser channel is A, a straight line orthogonal to the center line A at an outlet of the diffuser channel is B, and an angle between the rotation axis of the impeller and the straight line B is α, α≤60° is satisfied.

### TECHNICAL FIELD

The present disclosure relates to centrifugal compressors and turbochargers.

### BACKGROUND

The casing of a centrifugal compressor includes a scroll portion that forms a scroll channel on an outer circumferential side of an impeller, and a diffuser portion that forms a diffuser channel that supplies compressed air compressed by the impeller to the scroll channel.

In the diffuser channel of a centrifugal compressor, the area of an annular channel increases as it goes toward an outer side in the radial direction of the impeller whereby the kinetic energy of air is converted into pressure energy and the pressure is restored. Therefore, in order to reduce the pressure loss in the scroll channel of the centrifugal compressor and the outlet channel on the downstream side thereof, it is preferable to recover the pressure as much as possible in the diffuser channel, and for that purpose, it is effective to increase the outer diameter of the diffuser portion. However, since increasing the outer diameter of the diffuser portion leads to an increase in the size of the centrifugal compressor and deterioration of mountability, there is a limit in increasing the outer diameter of the diffuser portion.

In Patent Document 1, as a configuration for increasing the outer diameter of the diffuser portion while suppressing the increase in size of the centrifugal compressor, a diffuser channel including a curved channel portion that bends toward a front side in an axial direction of an impeller as it goes toward an outer side in a radial direction of the impeller is disclosed. According to this configuration, since the cross-section of the scroll channel is disposed on the front side in the axial direction of the impeller as compared with a diffuser channel composed of only the channel extending linearly along the radial direction, the outlet of the diffuser channel can be connected closer to the outer diameter side of the scroll channel. Therefore, it is possible to increase the outer diameter of the diffuser portion while suppressing the increase in the outer diameter of the scroll portion to suppress the increase in the size of the centrifugal compressor.

### CITATION LIST

### Patent Literature

Patent Document 1: JP3033902B1

### SUMMARY

### Technical Problem

In Patent Document 1, the extension angle of a curved channel portion around the cross-sectional center of a scroll channel is set to 30° or more and 210° or less. In this way, the air flow in the scroll channel and the air flow supplied from the diffuser channel to the scroll channel can be merged so that the flow rates thereof approach the same flow rate, and the loss due to the merging can be reduced.

However, according to the study of the inventors of the present application, if a curved channel portion satisfying the range of the extension angle is provided, there is a concern that the diffuser channel tends to be excessively long, the pressure loss of the diffuser channel increases, and the efficiency decreases. The extension angle that depends on the cross-sectional center of the scroll channel can change from a cross-section at the winding start of the scroll channel to a cross-section at the winding end of the scroll channel when the distance between the cross-sectional center of the scroll channel and the rotation axis of the impeller changes along the circumferential direction of the impeller. Therefore, the extension angle is not suitable as a parameter to be defined in order to realize the reduction of pressure loss.

With the foregoing in view, an object of at least one embodiment of the present invention is to provide a highly efficient centrifugal compressor and a turbocharger including the same.

### Solution to Problem

(1) A centrifugal compressor according to at least one embodiment of the present invention is a centrifugal compressor including an impeller and a casing, the casing including: a scroll portion that forms a scroll channel on an outer circumferential side of the impeller; and a diffuser portion that forms a diffuser channel that supplies compressed air compressed by the impeller to the scroll channel, wherein the diffuser channel includes a curved channel portion that bends toward a front side in an axial direction of the impeller as it goes toward an outer side in a radial direction of the impeller, and in a cross-section along a rotation axis of the impeller, when a center line of the diffuser channel is A, a straight line orthogonal to the center line A at an outlet of the diffuser channel is B, and an angle between the rotation axis of the impeller and the straight line B is α, α≤60° is satisfied.

According to the centrifugal compressor described in (1), by providing the curved channel portion in the diffuser channel, the diffuser channel can be connected to the scroll channel at a position closer to the outer side in the radial direction as compared with a case where the diffuser channel is composed of only a linear channel portion. Due to this, it is possible to increase the outer diameter of the diffuser portion to enhance the static pressure recovery effect of the diffuser channel while suppressing the increase in the outer diameter of the scroll portion. That is, it is possible to realize a highly efficient centrifugal compressor while suppressing the increase in size of the centrifugal compressor.

Further, when the curved channel portion is provided in the diffuser channel, the length of the diffuser channel tends to increase as compared with a case where the diffuser channel is composed of only the linear channel portion. However, since α≤60° is satisfied as described in (1), it is possible to suppress the length of the diffuser channel from becoming excessively long to suppress increase in the friction loss in the diffuser channel. Moreover, since α≤60° is satisfied, the distribution of the cross-sectional center of the scroll channel can be suppressed from being excessively inclined toward the inner diameter side, and the cross-sectional center on the winding end side of the scroll channel can be suppressed from greatly moving toward the inner diameter side with respect to the cross-sectional center on the winding start side. Therefore, it is possible to suppress acceleration of the flow in the scroll channel to suppress increase in the pressure loss. Accordingly, it is possible to realize a highly efficient centrifugal compressor.

(2) In some embodiment, in the centrifugal compressor according to (1), α≤40° is satisfied.

According to the centrifugal compressor described in (2), it is possible to enhance the effect described in (1) and realize a highly efficient centrifugal compressor.

(3) A centrifugal compressor according to at least one embodiment of the present invention is a centrifugal compressor including an impeller and a casing, the casing including: a scroll portion that forms a scroll channel on an outer circumferential side of the impeller;

and a diffuser portion that forms a diffuser channel that supplies compressed air compressed by the impeller to the scroll channel, wherein the diffuser channel includes a curved channel portion that bends toward a front side in an axial direction of the impeller as it goes toward an outer side in a radial direction of the impeller, and when a minimum value of a distance between a cross-sectional center of the scroll channel and a rotation axis of the impeller is Hmin, and a distance between an outlet of the diffuser channel and the rotation axis is R, Hmin≥0.9R is satisfied.

According to the centrifugal compressor described in (3), by providing the curved channel portion in the diffuser channel, the diffuser channel can be connected to the scroll channel at a position closer to the outer side in the radial direction as compared with a case where the diffuser channel is composed of only a linear channel portion. Due to this, it is possible to increase the outer diameter of the diffuser portion to enhance the static pressure recovery effect of the diffuser channel while suppressing the increase in the outer diameter of the scroll portion. That is, it is possible to realize a highly efficient centrifugal compressor while suppressing the increase in size of the centrifugal compressor.

When the curved channel portion is provided in the diffuser channel and the cross-sectional center of the scroll channel moves toward an inner side in the radial direction as it goes toward the downstream side of the scroll channel, the flow is accelerated in the scroll channel and the pressure loss is likely to occur. However, when Hmin≥0.9R is satisfied as described in (3), since the cross-sectional center on the winding end side of the scroll channel can be suppressed from moving greatly toward the inner diameter side with respect to the cross-sectional center on the winding start side, it is possible to suppress the acceleration of the flow in the scroll channel and suppress the increase in pressure loss. Therefore, a highly efficient centrifugal compressor can be realized.

(4) A centrifugal compressor according to at least one embodiment of the present invention is a centrifugal compressor including an impeller and a casing, the casing including: a scroll portion that forms a scroll channel on an outer circumferential side of the impeller; and a diffuser portion that forms a diffuser channel that supplies compressed air compressed by the impeller to the scroll channel, wherein the diffuser channel includes a curved channel portion that bends toward a front side in an axial direction of the impeller as it goes toward an outer side in a radial direction of the impeller, and in a cross-section along a rotation axis of the impeller, a channel wall surface that forms the curved channel portion includes a curved portion whose curvature increases as it goes toward an outer side in a radial direction of the impeller.

In the flow rate distribution at the outlet of an impeller, the flow rate on the shroud side is generally lower than that on the hub side. This is because the low-energy fluid accumulates on the shroud side and is discharged due to the centrifugal force of the impeller. In the diffuser channel provided on the downstream side of the impeller, since the static pressure recovers as it goes toward the outer side in the radial direction, backflow (peeling) is likely to occur in an outer circumferential portion of the diffuser channel by losing pressure gradient on the shroud side where the flow rate is small.

In contrast, in the curved channel portion, peeling of the outer circumferential portion of the diffuser channel is suppressed. This is because the diffuser channel has a curvature, so that the length of the diffuser channel can be increased under the condition that the outer diameter of the diffuser portion is constant, and the pressure gradient (reverse pressure gradient) which causes a backflow in the diffuser channel can be alleviated.

In this regard, in the centrifugal compressor described in (4), since the channel wall surface forming the curved channel portion includes the curved portion whose curvature increases as it goes toward the outer side in the radial direction, and the curvature on the outer side in the radial direction where peeling is likely to occur can be increased relatively, it is possible to effectively suppress occurrence of peeling in the diffuser channel. Therefore, a highly efficient centrifugal compressor can be realized.

(5) In some embodiment, in the centrifugal compressor according to (4), the curved portion includes a first arc portion having a first curvature and a second arc portion located on an outer side of the first arc portion in the radial direction and having a second curvature larger than the first curvature.

According to the centrifugal compressor described in (5), the occurrence of peeling in the diffuser channel can be effectively suppressed with a simple configuration.

(6) In some embodiment, in the centrifugal compressor according to (4), the curved portion has the curvature that continuously increases as it goes toward an outer side in the radial direction.

According to the centrifugal compressor described in (6), since the curvature of the curved portion is prevented from suddenly changing, peeling can be suppressed and the pressure loss in the diffuser channel can be reduced.

(7) In some embodiment, in the centrifugal compressor according to any one of (1), (2), and (4) to (6), when the minimum value of the distance between the cross-sectional center of the scroll channel and the rotation axis is Hmin and the distance between the outlet of the diffuser channel and the rotation axis is R, Hmin≥0.9R is satisfied.

When the curved channel portion is provided in the diffuser channel and the cross-sectional center of the scroll channel moves toward an inner side in the radial direction as it goes toward the downstream side of the scroll channel, the flow is accelerated in the scroll channel and the pressure loss is likely to occur. However, when Hmin≥0.9R is satisfied as described in (7), since the cross-sectional center on the winding end side of the scroll channel can be suppressed from moving greatly toward the inner diameter side with respect to the cross-sectional center on the winding start side, it is possible to suppress the acceleration of the flow in the scroll channel and suppress the increase in pressure loss. Therefore, a highly efficient centrifugal compressor can be realized.

(8) In some embodiment, in the centrifugal compressor according to any one of (1) to (3) and (7), in the cross-section along the rotation axis of the impeller, a channel wall surface that forms the curved channel portion includes a curved portion whose curvature increases as it goes toward an outer side in the radial direction.

According to the centrifugal compressor described in (8), since the channel wall surface forming the curved channel portion includes the curved portion whose curvature increases as it goes toward the outer side in the radial direction, and the curvature on the outer side in the radial direction where peeling is likely to occur can be increased relatively, it is possible to effectively suppress occurrence of peeling in the diffuser channel. Therefore, a highly efficient centrifugal compressor can be realized.

(9) In some embodiment, in the centrifugal compressor according to (8), the curved portion includes a first arc portion having a first curvature and a second arc portion located on an outer side of the first arc portion in the radial direction and having a second curvature larger than the first curvature.

According to the centrifugal compressor described in (9), the occurrence of peeling in the diffuser channel can be effectively suppressed with a simple configuration.

(10) In some embodiment, in the centrifugal compressor according to (8), the curved portion has a curvature that continuously increases as it goes toward an outer side in the radial direction.

According to the centrifugal compressor described in (10), since the curvature of the curved portion is prevented from suddenly changing, peeling can be suppressed and the pressure loss in the diffuser channel can be reduced.

(11) In some embodiment, in the centrifugal compressor according to any one of (1) to (10), the curved channel portion includes a widened channel width portion in which a channel width is widened as it goes toward an outer side in the radial direction.

According to the centrifugal compressor described in (11), since the pressure recovery in the diffuser channel can be promoted while suppressing the occurrence of peeling by the curved channel portion, a highly efficient centrifugal compressor can be realized.

(12) In some embodiment, in the centrifugal compressor according to any one of (1) to (10), the curved channel portion includes a reduced channel width portion in which the channel width is reduced as it goes toward an outer side in the radial direction.

According to the centrifugal compressor described in (12), the peeling suppression effect of the curved channel portion can be further enhanced by the reduced channel width portion. Therefore, even when a sufficient curvature cannot be given to the diffuser channel due to restrictions on the shape and dimensions, it is possible to effectively suppress peeling in the diffuser channel and realize a highly efficient centrifugal compressor.

(13) In some embodiment, in the centrifugal compressor according to any one of (1) to (12), in the cross-section along the rotation axis of the impeller, when a frontmost position in the axial direction among the positions on the center line of the diffuser channel is P1, a rearmost position in the axial direction is P2, an outermost position in the radial direction is P3, an innermost position in the radial direction is P4, a distance between the position P1 and the position P2 in the axial direction is ΔZ, and a distance between the position P3 and the position P4 in the radial direction is ΔR, ΔZ/ΔR≤0.6 is satisfied.

According to the centrifugal compressor described in (13), it is possible to suppress the length of the diffuser channel from becoming excessively long to suppress increase in the friction loss in the diffuser channel. Moreover, the distribution of the cross-sectional center of the scroll channel can be suppressed from being excessively inclined toward the inner diameter side, and the cross-sectional center on the winding end side of the scroll channel can be suppressed from greatly moving toward the inner diameter side with respect to the cross-sectional center on the winding start side. Therefore, it is possible to suppress acceleration of the flow in the scroll channel to suppress increase in the pressure loss. Accordingly, it is possible to realize a highly efficient centrifugal compressor.

(14) In some embodiment, in the centrifugal compressor according to any one of (1) to (13), in the cross-section along the rotation axis of the impeller, the curved channel portion occupies a range of 30% or more of a presence range of the diffuser channel in the radial direction.

According to the centrifugal compressor described in (14), the increase in the curvature of the diffuser channel can be suppressed without making the diffuser channel excessively long under the condition that the presence range of the diffuser channel in the radial direction is fixed. Therefore, the pressure loss in the diffuser channel can be reduced.

(15) In some embodiment, the centrifugal compressor according to any one of (1) to (14) further includes: a compressor cover including at least a portion of the scroll portion and a back cover connected to the compressor cover to form the diffuser channel between the compressor cover and the back cover, and a distance between an inner end in the radial direction of a connection portion between the compressor cover and the back cover and the rotation axis of the impeller is larger than the distance between the outlet of the diffuser channel and the rotation axis of the impeller.

According to the centrifugal compressor described in (15), it is possible to realize an open scroll structure in which the compressor cover opens to a position closer to the outer side in the radial direction than the outlet of the diffuser channel. Therefore, it is possible to insert a tool such as a cutting tool into the diffuser channel and easily process the shape of the curved channel portion.

(16) A turbocharger according to at least one embodiment of the present invention is a turbocharger including the centrifugal compressor according to any one of (1) to (15).

According to the turbocharger described in (16), since the centrifugal compressor according to any one of (1) to (15) is provided, a highly efficient turbocharger can be realized.

### Advantageous Effects

According to at least one embodiment of the present invention, a highly efficient centrifugal compressor and a turbocharger including the same are provided.

### BRIEF DESCRIPTION OF DRAWINGS

FIG. 1 is a schematic cross-sectional view along an axial direction of a centrifugal compressor 2 according to an embodiment.

FIG. 2 is a diagram for explaining the definition of an outlet inclination angle α of a diffuser channel 12 illustrated in FIG. 1, and schematically illustrates an example of a cross-section perpendicular to the axial direction of a scroll channel 8 of the centrifugal compressor 2 illustrated in FIG. 1.

FIG. 3 is a diagram illustrating a portion of a centrifugal compressor according to a comparative example.

FIG. 4 is a diagram illustrating a portion of the centrifugal compressor 2 according to an embodiment.

FIG. 5 is a diagram illustrating a portion of the centrifugal compressor 2 according to another embodiment.

FIG. 6 is a diagram illustrating a portion of a centrifugal compressor according to another comparative example.

FIG. 7 illustrates the relationship between the length of the diffuser channel 12 and the area of an outlet 12a of the diffuser channel 12 when the diffuser channel 12 is formed along a single arc in comparison with a case where the diffuser channel is formed in a linear form.

FIG. 8 is a diagram illustrating the relationship between an air flow rate and efficiency in the centrifugal compressor 2 according to an embodiment in which α≤60° is satisfied and a conventional centrifugal compressor that does not satisfy α≤60° for each rotation speed of the centrifugal compressor.

FIG. 9 illustrates the relationship between Hmin/R, which is the ratio of the minimum value Hmin to the outer diameter R of the diffuser portion 14, and the rate of increase in pressure loss in the scroll channel.

FIG. 10 is a diagram illustrating the relationship between the outlet inclination angle α of the diffuser channel and the ratio Hmin/R.

FIG. 11 is a diagram illustrating a cross-section along the rotation axis O of the impeller 4, of the diffuser channel 12 and the scroll channel 8 of the centrifugal compressor 2 according to another embodiment.

FIG. 12 is a diagram illustrating a cross-section along the rotation axis O of the impeller 4, of the diffuser channel 12 and the scroll channel 8 of the centrifugal compressor 2 according to another embodiment.

FIG. 13 is a diagram illustrating a cross-section along the rotation axis O of the impeller 4, of the diffuser channel 12 and the scroll channel 8 of the centrifugal compressor 2 according to another embodiment.

FIG. 14 is a diagram illustrating an example of a flow analysis result of a linear diffuser channel.

FIG. 15 is a diagram illustrating an example of a flow analysis result of the diffuser channel 12 including a curved channel portion 16.

FIG. 16 is a diagram illustrating a cross-section along the rotation axis O of the impeller 4, of the diffuser channel 12 and the scroll channel 8 of the centrifugal compressor 2 according to another embodiment.

FIG. 17 is a diagram illustrating the relationship between the length of the diffuser channel 12 and the area of the outlet 12a of the diffuser channel 12 when the diffuser channel 12 is formed along a single arc in comparison with a case where the diffuser channel is formed in a linear form.

FIG. 18 is a diagram illustrating a cross-section along the rotation axis O of the impeller 4, of the diffuser channel 12 of the centrifugal compressor 2 according to another embodiment.

FIG. 19 is a diagram illustrating a cross-section along the rotation axis O of the impeller 4, of the diffuser channel 12 of the centrifugal compressor 2 according to another embodiment.

FIG. 20 is a diagram illustrating a cross-section along the rotation axis O of the impeller 4, of the diffuser channel 12 of the centrifugal compressor 2 according to another embodiment.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments or illustrated by drawings shall be interpreted as illustrative only and not limitative of the scope of the present invention.

For example, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For example, an expression of an equal state such as “same” “equal” and “uniform” shall not be construed as indicating only the state in which the feature is strictly equal, but also includes a state in which there is a tolerance or a difference that can still achieve the same function.

For example, an expression of a shape such as a rectangular shape or a cylindrical shape shall not be construed as only the geometrically strict shape, but also includes a shape with unevenness or chamfered corners within the range in which the same effect can be achieved.

Furthermore, in the present specification, an expression such as “comprise”, “include”, “have”, “contain” and “constitute” are not intended to be exclusive of other components.

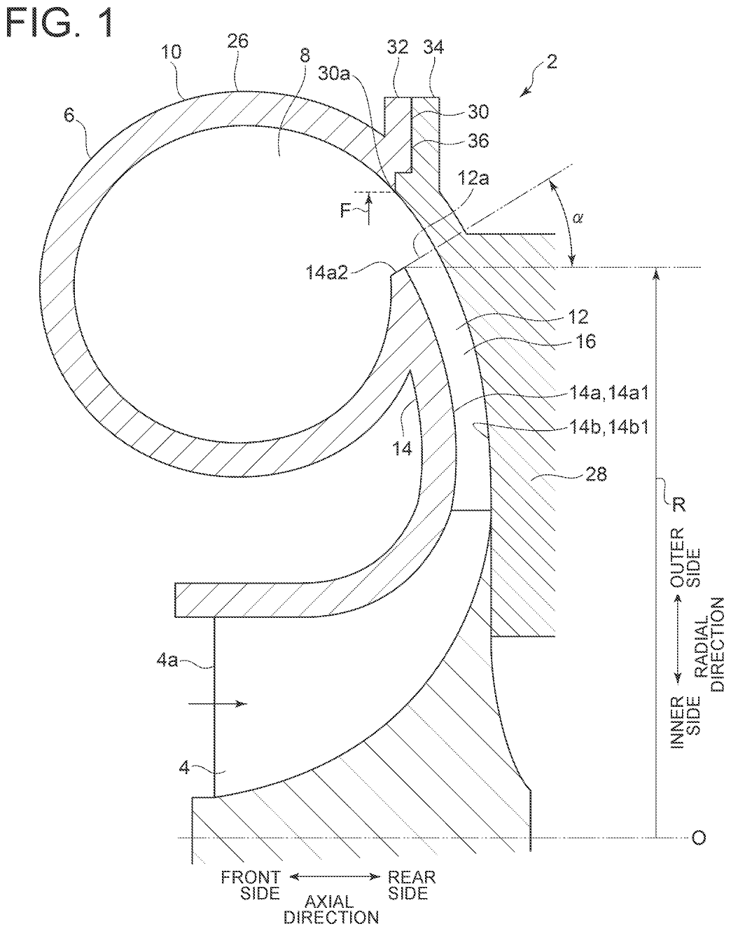

FIG. 1 is a schematic cross-sectional view along the rotation axis O of a centrifugal compressor 2 according to an embodiment. The centrifugal compressor 2 can be applied to, for example, turbo chargers for automobiles or ships, and other industrial centrifugal compressors, blowers, and the like.

For example, as illustrated in FIG. 1, the centrifugal compressor 2 includes an impeller 4 and a casing 6 that houses the impeller 4. In the following, the axial direction of the impeller 4 is simply referred to as an “axial direction”, the radial direction of the impeller 4 is simply referred to as a “radial direction”, and the circumferential direction of the impeller 4 is simply referred to as a “circumferential direction”. The upstream side of the flow along the axial direction at the position of an inlet 4a of the impeller 4 is referred to as a “front side” in the axial direction, and the downstream side of the flow along the axial direction at the position of the inlet 4a of the impeller 4 is referred to as a “rear side” in the axial direction.

The casing 6 includes a scroll portion 10 that forms a scroll channel 8 on the outer circumferential side of the impeller 4 and a diffuser portion 14 that forms a diffuser channel 12 that supplies compressed air compressed by the impeller 4 to the scroll channel 8. In the cross-section along the rotation axis O of the impeller 4, the scroll channel 8 has a substantially circular shape.

The diffuser portion 14 is composed of a pair of channel walls 14a and 14b forming the diffuser channel 12, and the diffuser channel 12 includes a curved channel portion 16 that bends toward the front side in the axial direction as it goes toward the outer side in the radial direction. The outer diameter R of the diffuser portion 14 is constant in the circumferential direction. The outer diameter R of the diffuser portion 14 means the distance R between the outlet 12a of the diffuser channel 12 and the rotation axis O of the impeller 4, that is, the distance R between an outer circumferential edge 14a2 of the channel wall 14a and the rotation axis O of the impeller 4.

In this way, by providing the curved channel portion 16 in the diffuser channel 12, the diffuser channel 12 can be connected to the scroll channel 8 at a position closer to the outer side in the radial direction as compared with a case where the diffuser channel 12 is composed of only a linear channel portion. Due to this, it is possible to increase the outer diameter of the diffuser portion 14 to enhance the static pressure recovery effect of the diffuser channel 12 while suppressing the increase in the outer diameter of the scroll portion 10. That is, it is possible to realize a highly efficient centrifugal compressor 2 while suppressing the increase in size of the centrifugal compressor 2.

In the exemplary embodiment illustrated in FIG. 1, the casing 6 includes a compressor cover 26 that includes at least a portion of the scroll portion 10 and surrounds the impeller 4 and a back cover 28 connected to the compressor cover 26 to form the diffuser channel 12 between the compressor cover 26 and the back cover 28. The distance F between an inner end 30a in the radial direction of a connection portion 30 between the compressor cover 26 and the back cover 28 and the rotation axis O of the impeller 4 is larger than the distance R between the outlet 12a of the diffuser channel 12 and the rotation axis O of the impeller 4. In the illustrated exemplary embodiment, the connection portion 30 is composed of a flange 32 of the compressor cover 26 and a flange 34 of the back cover 28, and the inner end 30a means an inner end in the radial direction of a contact surface 36 between the flange 32 and the flange 34.

In this way, by setting the distance F to be larger than the distance R, it is possible to realize an open scroll structure in which the compressor cover 26 opens to a position closer to the outer side in the radial direction than the outlet 12a of the diffuser channel 12. Therefore, it is possible to insert a tool such as a cutting tool into the diffuser channel 12 and easily process the shape of the curved channel portion 16.

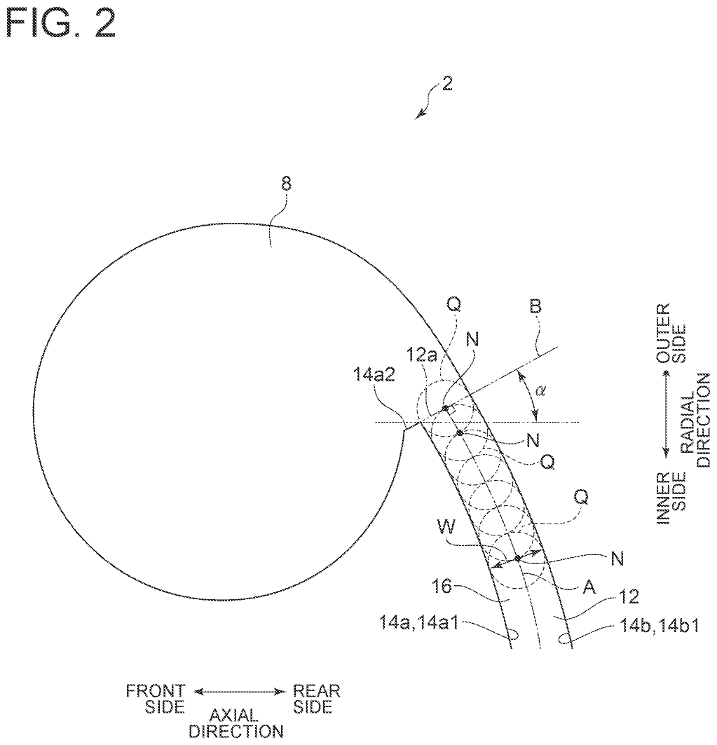

FIG. 2 is a diagram for explaining the definition of an outlet inclination angle α of the diffuser channel 12 illustrated in FIG. 1, and illustrates an example of a cross-section along the rotation axis O of a portion of the centrifugal compressor 2.

Here, as illustrated in FIG. 2, in the cross-section along the rotation axis O (see FIG. 1) of the impeller 4, the center line of the diffuser channel 12 is defined as A, a straight line orthogonal to the center line A at the outlet 12a of the diffuser channel 12 is defined as B, and the angle between the axial direction and the straight line B is defined as a (the outlet inclination angle of the diffuser channel 12). The center line A of the diffuser channel 12 means a line connecting the center N of an inscribed circle Q of the diffuser channel 12 along the direction of flow in the diffuser channel 12 in the cross-section along the rotation axis O of the impeller 4 (in the illustrated embodiment, a line connecting the center of a channel width W of the diffuser channel 12 along the direction of flow in the diffuser channel 12). The inscribed circle Q of the diffuser channel 12 means a circle in contact with both of a pair of channel wall surfaces 14a1 and 14b1 forming the diffuser channel 12 in the cross-section along the rotation axis O of the impeller 4.

As illustrated in FIGS. 1 and 2, the diffuser channel 12 of the centrifugal compressor 2 is configured to satisfy α≤60°.

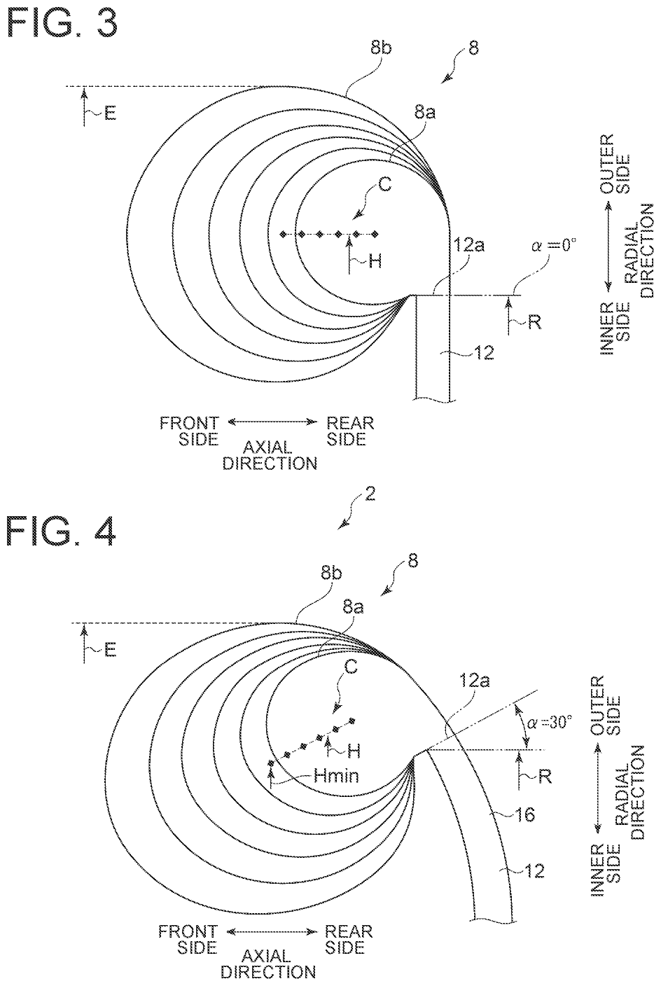

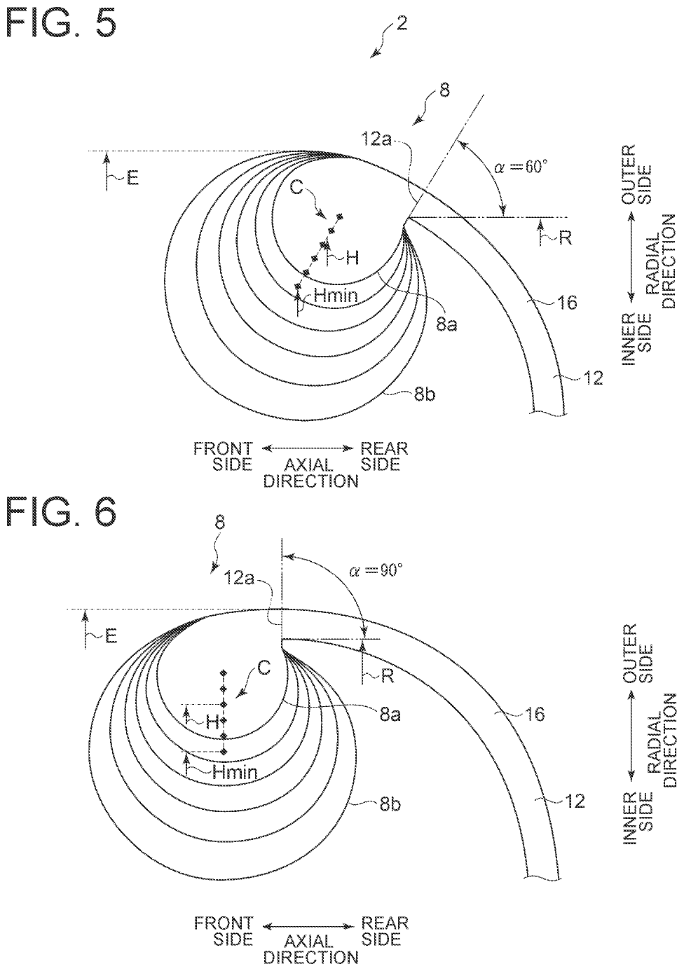

Here, the effect obtained by satisfying α≤60° will be described with reference to FIGS. 3 to 7. FIG. 3, FIG. 4, FIG. 5 and FIG. 6 schematically illustrate a partial configuration of a centrifugal compressor satisfying α=0°, α=30°, α=60° and α=90°, respectively. FIGS. 3 and 6 each illustrate a partial configuration of a centrifugal compressor according to one comparative embodiment, and FIGS. 4 and 5 each illustrate a partial configuration of a centrifugal compressor 2 according to one embodiment.

FIG. 3 illustrates a diffuser channel 12 formed in a linear form along the radial direction. The curved channel portions 16 illustrated in FIGS. 4 to 6 are formed along a single arc and have a single curvature equal to each other. In some configurations illustrated in FIGS. 3 to 6, the outlet inclination angles a are different from each other under the condition that the maximum outer diameters E of the scroll channels 8 (the outer diameters at the position of a winding end 8b of the scroll channel 8) are equal to each other. FIGS. 3 to 6 each illustrate a change in the cross-sectional shape of the scroll channel 8 and a change in the cross-sectional center C from a winding start 8a to the winding end 8b of the scroll channel 8.

In the configuration illustrated in FIG. 3, the distance H between the cross-sectional center C of the scroll channel 8 and the rotation axis O (see FIG. 1) of the impeller 4 is constant in the circumferential direction. In contrast, in the configuration illustrated in FIGS. 4 to 6, the cross-sectional center C of the scroll channel 8 moves toward an inner side in the radial direction as it goes toward the downstream side (downstream side in the rotation direction of the impeller 4) in the circumferential direction. Further, as illustrated in FIGS. 3 to 6, it can be seen that the distribution of the cross-sectional center C of the scroll channel 8 is inclined toward the inner diameter side as the outlet inclination angle α increases. Further, as the distance H between the cross-sectional center C of the scroll channel 8 and the rotation axis O of the impeller 4 decreases, the flow of the scroll channel 8 accelerates according to the law of conservation of angular momentum, and the efficiency of the centrifugal compressor 2 decreases. Therefore, if the outlet inclination angle α is excessively large, the efficiency of the centrifugal compressor 2 will decrease.

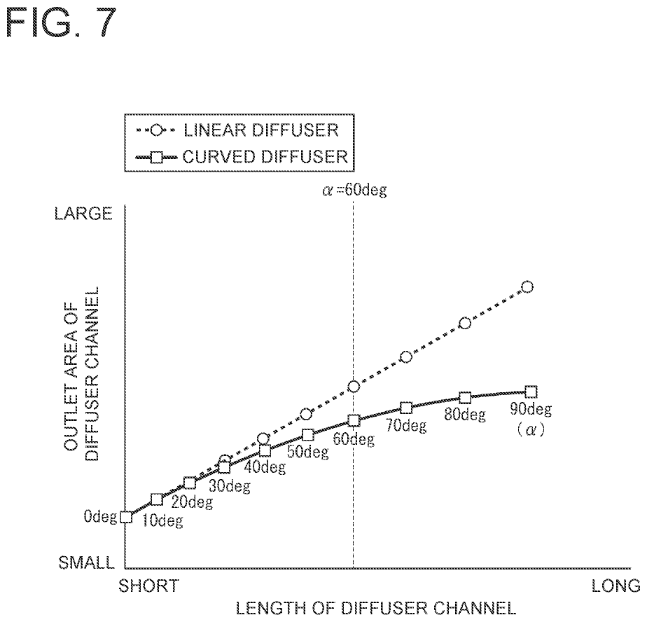

FIG. 7 illustrates the relationship between the length of the diffuser channel 12 and the area of the outlet 12a of the diffuser channel 12 when the diffuser channel 12 is formed along a single arc in comparison with a case where the diffuser channel is formed in a linear form. FIG. 7 illustrates the change in the area of the outlet 12a when the outlet inclination angle α is changed from 0° to 90° at intervals of 10°.

As illustrated in FIG. 7, when α>60° is satisfied, it can be seen that the ratio of the increase in the area of the outlet 12a to the increase in the length of the diffuser channel 12 (and the ratio of the increase in the outer diameter of the diffuser portion 14 to the increase in the length of the diffuser channel 12) is significantly reduced. This indicates that, when α>60° is satisfied, the demerit of the increase in friction loss due to the increase in the diffuser channel 12 tends to increase more than the merit of the static pressure recovery effect by lengthening the diffuser channel 12 and increasing the outer diameter of the diffuser portion 14.

In contrast, when α≤60° is satisfied, it is possible to suppress the length of the diffuser channel 12 from becoming excessively long to suppress increase in the friction loss in the diffuser channel 12 while increasing the outer diameter of the diffuser portion 14 to enhance the static pressure recovery effect. The distribution of the cross-sectional center C of the scroll channel 8 can be suppressed from being excessively inclined toward the inner diameter side, and the cross-sectional center C on the winding end 8b side of the scroll channel 8 can be suppressed from greatly moving toward the inner diameter side with respect to the cross-sectional center C on the winding start 8a side. Therefore, it is possible to suppress acceleration of the flow in the scroll channel 8 to suppress increase in the pressure loss. Accordingly, it is possible to realize a highly efficient centrifugal compressor 2.

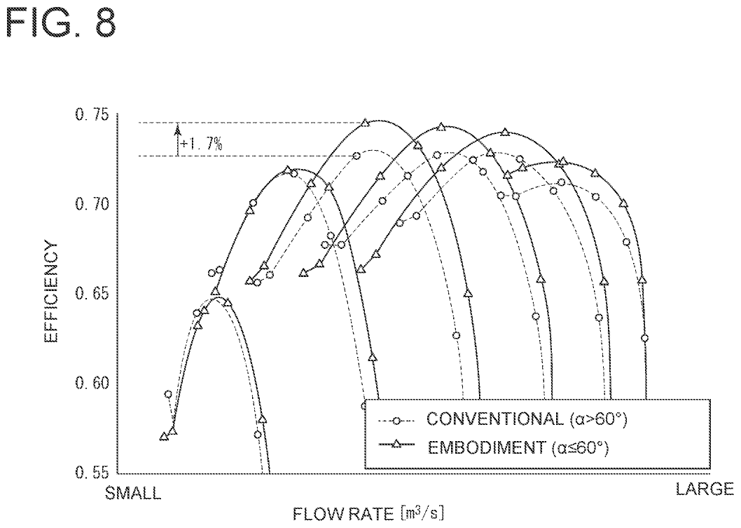

FIG. 8 is a diagram illustrating the relationship between an air flow rate and efficiency in the centrifugal compressor 2 that satisfy α≤60° and a conventional centrifugal compressor that does not satisfy α≤60° for each rotation speed of the centrifugal compressor. In FIG. 8, a solid line illustrates the performance test result of the centrifugal compressor 2 according to one embodiment, and a broken line illustrates the performance test result of the conventional centrifugal compressor. Both performance test results are test results under the condition that the outer diameter of the diffuser portion 14 is the same. According to the performance test results illustrated in FIG. 8, it was clarified that in one embodiment, the efficiency can be improved by about 1.7% as compared with the conventional centrifugal compressor.

In some embodiments, for example, as illustrated in FIG. 4, when the minimum value of the distance H between the cross-sectional center C of the scroll channel 8 and the rotation axis O of the impeller 4 is Hmin and the outer diameter of the diffuser portion 14 is R, Hmin≥0.9R is satisfied.

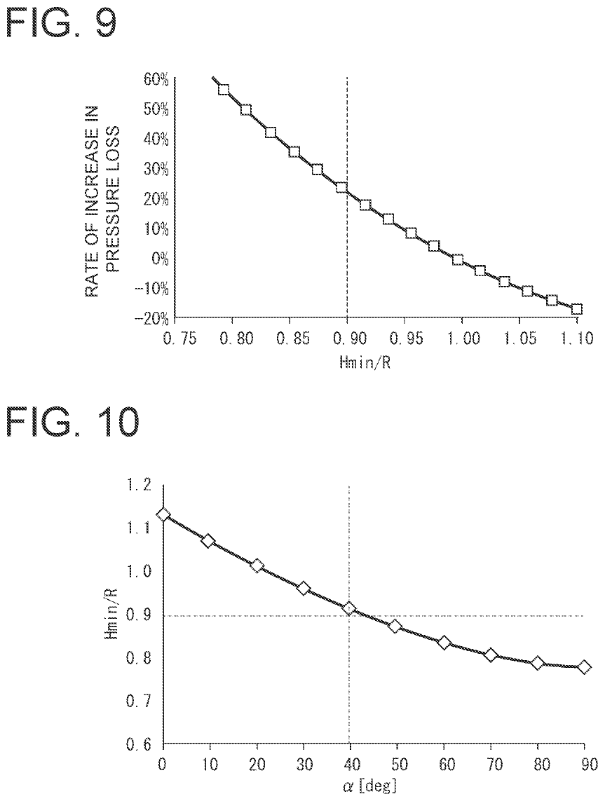

FIG. 9 illustrates the relationship between Hmin/R, which is the ratio of the minimum value Hmin to the outer diameter R of the diffuser portion 14, and the rate of increase in pressure loss in the scroll channel 8. In FIG. 9, the rate of increase in pressure loss illustrated on the vertical axis indicates the rate of increase based on the pressure loss when the ratio Hmin/R is 1.

As illustrated in FIG. 9, it can be seen that, in the region where the ratio Hmin/R is less than 0.9, the pressure loss increases sharply as the ratio Hmin/R decreases. This is because the flow rate in the scroll channel 8 increases toward the inner circumferential side according to the law of conservation of angular momentum, and the pressure loss is proportional to the square of the flow rate.

In contrast, in the region where Hmin/R≥0.9 is satisfied, the change in the rate of increase in pressure loss with respect to the change in the ratio Hmin/R is gentle, and the increase in pressure loss in the scroll channel 8 can be suppressed. Therefore, it is possible to realize a highly efficient centrifugal compressor 2 by increasing the outer diameter of the diffuser portion 14 to enhance the static pressure recovery effect and suppressing an increase in pressure loss.

FIG. 10 is a diagram illustrating the relationship between the outlet inclination angle α of the diffuser channel 12 and the ratio Hmin/R.

As illustrated in FIG. 10, when α≤40° is satisfied, it becomes easy to set the ratio Hmin/R to be 0.9 or more. Therefore, it is more preferable to satisfy α≤40°.

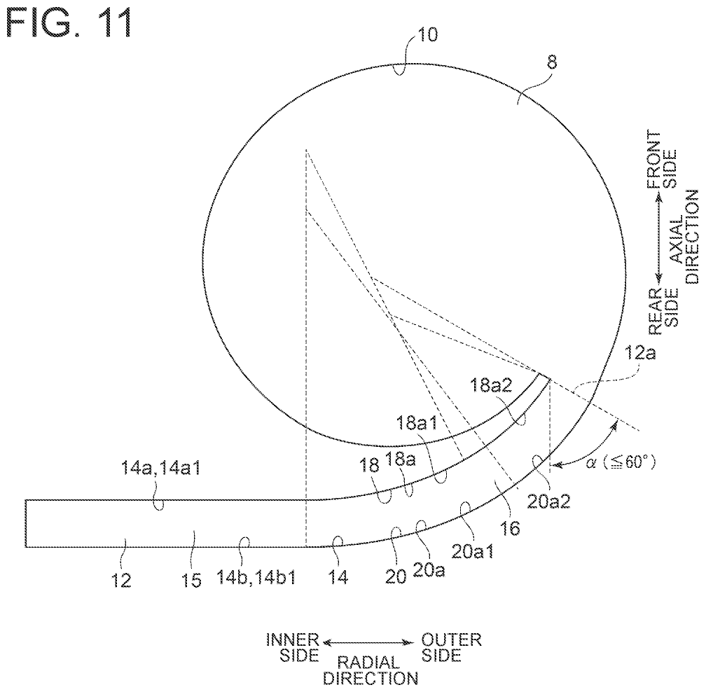

In some embodiments, for example, as illustrated in FIGS. 11 to 13, in a cross-section along the rotation axis O of the impeller 4, the pair of channel wall surfaces 18 and 20 forming the curved channel portion 16 include curved portions 18a and 20a whose curvature increases toward the outer side in the radial direction. In the illustrated exemplary embodiment, the channel wall surface 18 on the front side in the axial direction among the pair of channel wall surfaces 18 and 20 includes the curved portion 18a whose curvature increases as it goes toward the outer side in the radial direction, and the channel wall surface 20 on the rear side in the axial direction among the pair of channel wall surfaces 18 and 20 includes the curved portion 20a whose curvature increases as it goes toward the outer side in the radial direction. Further, in the illustrated exemplary embodiment, the curved channel portion 16 is provided on the outer side in the radial direction of the linear channel portion 15 included in the diffuser channel 12 to connect the linear channel portion 15 and the scroll channel 8.

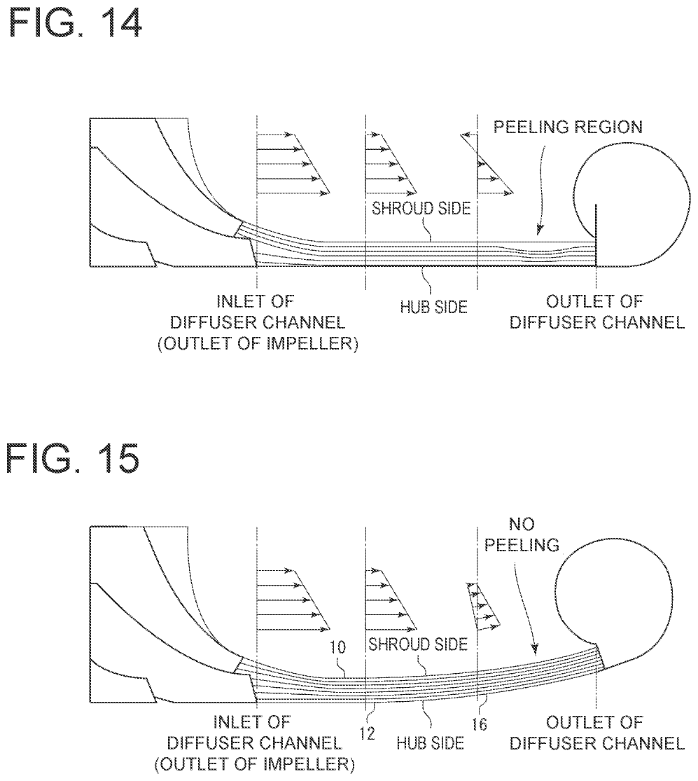

Here, the peeling suppressing effect of the curved channel portion 16 will be described with reference to FIGS. 14 and 15. FIG. 14 is a diagram illustrating an example of the flow analysis result of the linear diffuser channel. FIG. 15 is a diagram illustrating an example of the flow analysis result of the diffuser channel 12 including the curved channel portion 16.

As illustrated in FIG. 14, in the flow rate distribution at the outlet of an impeller, the flow rate on the shroud side is generally lower than that on the hub side. This is because the low-energy fluid accumulates on the shroud side and is discharged due to the centrifugal force of the impeller. In the diffuser channel provided on the downstream side of the impeller, since the static pressure recovers as it goes toward the outer side in the radial direction, backflow (peeling) is likely to occur in an outer circumferential portion of the diffuser channel by losing pressure gradient on the shroud side where the flow rate is small.

In contrast, as illustrated in FIG. 15, it can be seen that in the curved channel portion 16, peeling of the outer circumferential portion of the diffuser channel 12 is suppressed as compared with the configuration illustrated in FIG. 14. This is because the diffuser channel 12 has a curvature, so that the length of the diffuser channel 12 can be increased under the condition that the outer diameter of the diffuser portion 14 is constant, and the pressure gradient (reverse pressure gradient) which causes a backflow in the diffuser channel 12 can be alleviated.

In this regard, in some embodiments illustrated in FIGS. 11 to 13, the channel wall surfaces 18 and 20 forming the curved channel portion 16 include the curved portions 18a and 20a whose curvatures increase as they go toward the outer side in the radial direction in the cross-section along the rotation axis O of the impeller 4, and the curvature on the outer side in the radial direction where peeling is likely to occur can be increased relatively. Therefore, it is possible to effectively suppress occurrence of peeling in the diffuser channel 12.

In some embodiments, for example, as illustrated in FIG. 11, the curved portion 18a has an arc portion 18a1 having a curvature J1 and an arc portion 18a2 located on the outer side of the arc portion 18a1 in the radial direction and having a curvature J2 larger than the curvature J1. The curved portion 20a includes an arc portion 20a1 having a curvature K1 and an arc portion 20a2 located on the outer side of the arc portion 20a1 in the radial direction and having a curvature K2 larger than the curvature K1. As described above, the curvature of each of the curved portions 18a and 20a gradually increases as it goes toward the outer side in the radial direction.

According to such a configuration, since the curvature on the outer side in the radial direction where peeling is likely to occur can be relatively increased with a simple configuration, the occurrence of peeling in the diffuser channel 12 can be effectively suppressed with a simple configuration. In another embodiment, each of the curved portions 18a and 20a may be composed of three or more arc portions.

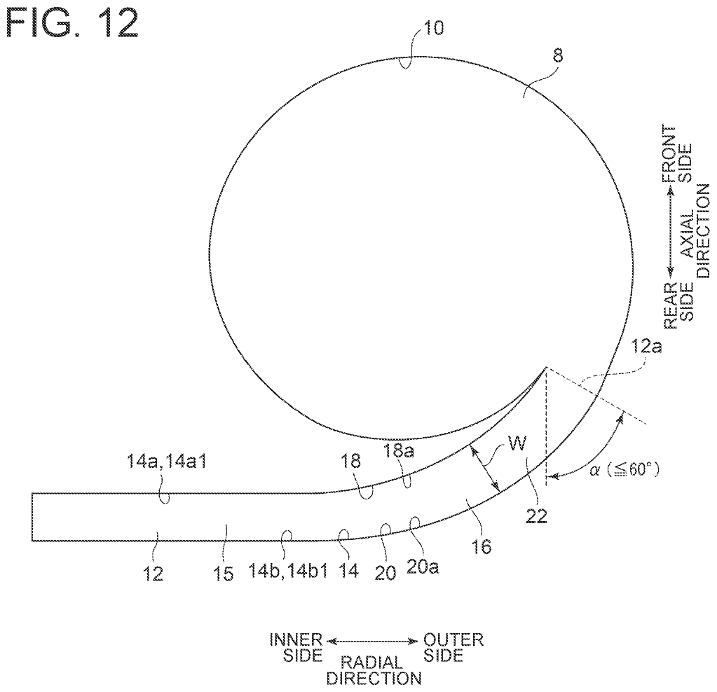

In some embodiments, for example, in the configuration illustrated in FIG. 12, each of the curved portions 18a, 20a has a curvature that continuously increases as it goes toward the outer side in the radial direction.

According to this configuration, by preventing the curvatures of the curved portions 18a and 20a from suddenly changing, peeling can be suppressed and the pressure loss in the diffuser channel can be reduced.

In some embodiments, for example, as illustrated in FIG. 12, the curved channel portion 16 includes a widened channel width portion 22 in which the channel width W increases as it goes toward the outer side in the radial direction.

According to such a configuration, since the pressure recovery in the diffuser channel 12 can be promoted while suppressing the occurrence of peeling by the curved channel portion 16, a highly efficient centrifugal compressor 2 can be realized.

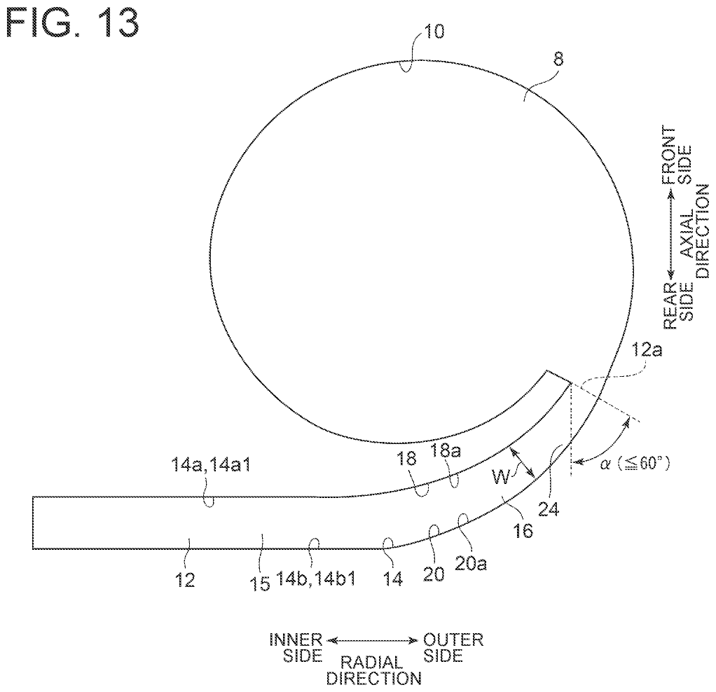

In some embodiments, for example, as illustrated in FIG. 13, the diffuser channel 12 includes a reduced channel width portion 24 in which the channel width W decreases as it goes toward the outer side in the radial direction.

According to such a configuration, the peeling suppression effect of the curved channel portion 16 can be further enhanced by the reduced channel width portion 24. Therefore, even when a sufficient curvature cannot be given to the diffuser channel 12 due to restrictions on the shape and dimensions, it is possible to effectively suppress peeling in the diffuser channel 12 and realize a highly efficient centrifugal compressor 2.

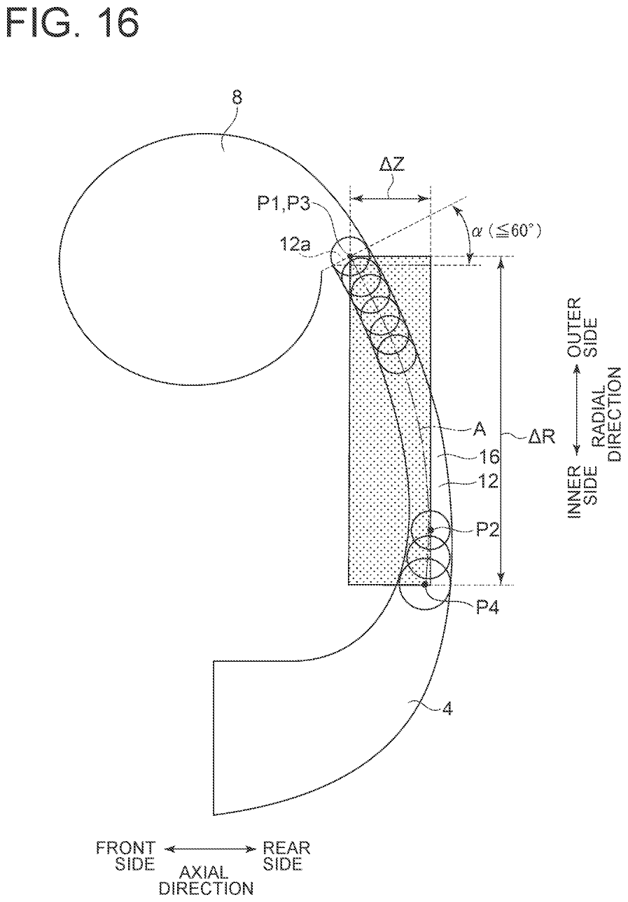

In some embodiments, for example, as illustrated in FIG. 16, in the cross-section along the rotation axis O of the impeller 4, when a frontmost position in the axial direction among the positions on the center line A of the diffuser channel 12 is P1, a rearmost position in the axial direction is P2, an outermost position in the radial direction is P3, an innermost position in the radial direction is P4, a distance between the position P1 and the position P2 in the axial direction is ΔZ, and a distance between the position P3 and the position P4 in the radial direction is ΔR, ΔZ/ΔR≤0.6 is satisfied.

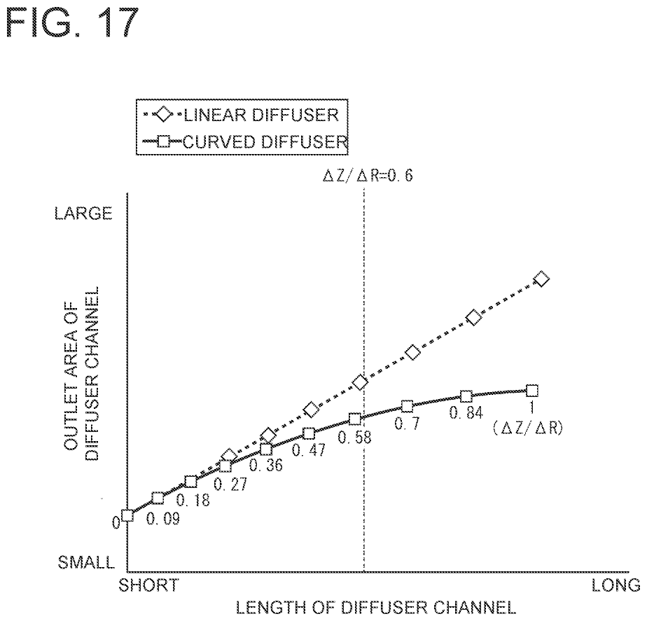

FIG. 17 is a diagram illustrating the relationship between the length of the diffuser channel 12 and the area of the outlet 12a of the diffuser channel 12 when the diffuser channel 12 is formed along a single arc in comparison with a case where the diffuser channel is formed in a linear form. FIG. 17 illustrates the change in the area of the outlet 12a of the diffuser channel 12 when ΔZ/ΔR is changed to 0, 0.09, 0.18, 0.27, 0.36, 0.47, 0.58, 0.7, 0.84, and 1.

As illustrated in FIG. 17, it can be seen that, when ΔZ/ΔR>0.6 is satisfied, the ratio of the increase in the area of the outlet 12a to the increase in the length of the diffuser channel 12 (and the ratio of the increase in the outer diameter of the diffuser portion to the increase in the length of the diffuser channel 12) decreases significantly. This indicates that, when ΔZ/ΔR>0.6 is satisfied, the demerit of the increase in friction loss due to the increase in the diffuser channel 12 tends to increase more than the merit of the static pressure recovery effect by lengthening the diffuser channel 12 and increasing the outer diameter of the diffuser portion.

In contrast, when ΔZ/ΔR≤0.6 is satisfied, it is possible to suppress the length of the diffuser channel 12 from becoming excessively long to suppress increase in the friction loss in the diffuser channel 12 while increasing the outer diameter of the diffuser portion 14 to enhance the static pressure recovery effect. The distribution of the cross-sectional center C of the scroll channel 8 can be suppressed from being excessively inclined toward the inner diameter side, and the cross-sectional center C on the winding end 8b side of the scroll channel 8 can be suppressed from greatly moving toward the inner diameter side with respect to the cross-sectional center C on the winding start 8a side. Therefore, it is possible to suppress acceleration of the flow in the scroll channel 8 to suppress increase in the pressure loss. Accordingly, it is possible to realize a highly efficient centrifugal compressor 2.

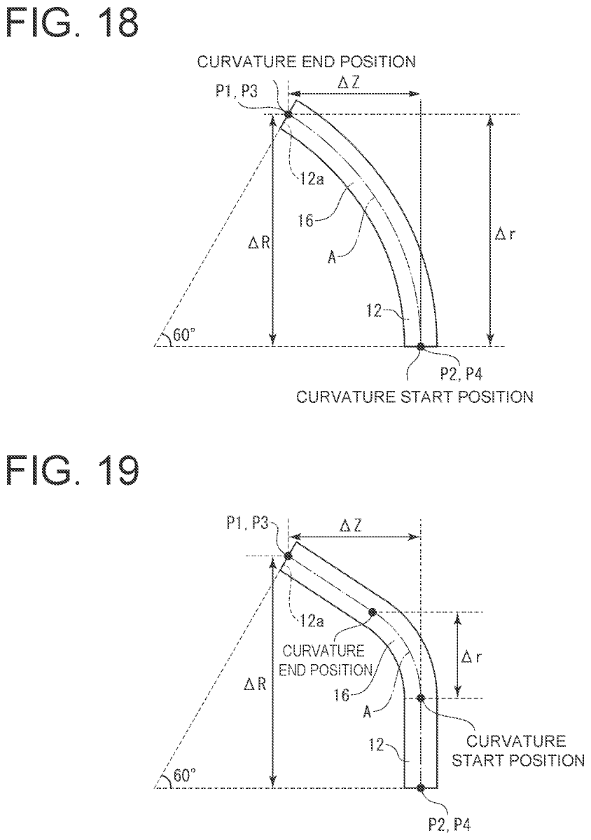

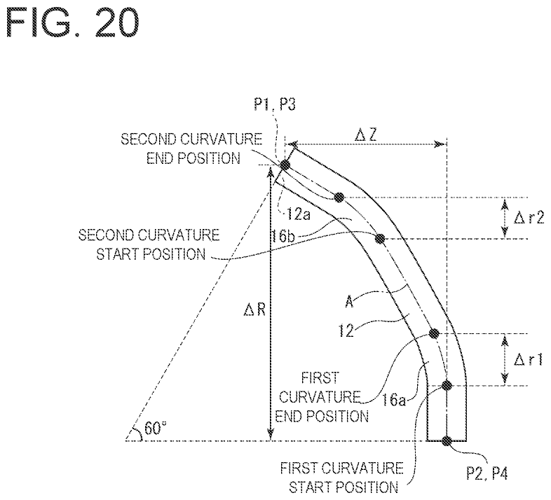

In some embodiments, for example, as illustrated in FIG. 16, in the cross-section along the rotation axis O of the impeller, the curved channel portion 16 occupies 30% or more (more preferably 50% or more) of the presence range ΔR (the range from the position P3 to the position P4 in the radial direction) of the diffuser channel 12 in the radial direction. The curved channel portion 16 may occupy 100% of the presence range ΔR of the diffuser channel in the radial direction as illustrated in FIG. 18, for example. The curved channel portion 16 may be provided at one place in the middle portion or at the end of the diffuser channel 12 as illustrated in FIG. 19, for example, and may be provided at two places or more as illustrated in FIG. 20, for example.

When a plurality of curved channel portions 16 is provided as illustrated in FIG. 20, the range obtained by adding the presence ranges of the plurality of curved channel portions 16 in the radial direction preferably occupies 30% or more of the presence range ΔR of the diffuser channel in the radial direction. For example, when two curved channel portions 16 (16a, 16b) are provided as illustrated in FIG. 20, the range obtained by adding the presence range Δr1 of the curved channel portion 16a and the presence range Δr2 of the curved channel portion 16b in the radial direction preferably occupies 30% or more of the presence range ΔR of the diffuser channel 12 in the radial direction.

In this way, since the curved channel portion 16 occupies 30% or more of the presence range ΔR of the diffuser channel in the radial direction, the increase in the curvature of the diffuser channel 12 can be suppressed without making the diffuser channel 12 excessively long under the condition that the presence range ΔR of the diffuser channel 12 in the radial direction is fixed. Therefore, the pressure loss in the diffuser channel 12 can be reduced.

The present invention is not limited to the above-described embodiments but includes modifications of the above-described embodiments and appropriate combinations of these modifications.

### REFERENCE SIGNS LIST

2 Centrifugal compressor
4 Impeller
4a Inlet
6 Casing
8 Scroll channel
10 Scroll portion
12 Diffuser channel
12a Outlet
14 Diffuser portion
14a Channel wall
14a1 Channel wall surface
14a2 Outer circumferential edge
14b Channel wall
14b1 Channel wall surface
15 Linear channel portion
16 (16a, 16b) Curved channel portion
18 Channel wall surface
18a Curved portion
18a1 Arc portion (first arc portion)
18a2 Arc portion (second arc portion)
20 Channel wall surface
20a Curved portion
20a1 Arc portion (first arc portion)
20a2 Arc portion (second arc portion)
22 Widened channel width portion
24 Reduced channel width portion
26 Compressor cover
28 Back cover
30 Connection portion
30a Inner end
32, 34 Flange
36 Contact surface

1. A centrifugal compressor comprising an impeller and a casing,
the casing including:
a scroll portion that forms a scroll channel on an outer circumferential side of the impeller; and
a diffuser portion that forms a diffuser channel that supplies compressed air compressed. by the impeller to the scroll channel, wherein
the diffuser channel includes a curved channel portion that bends toward a front side in an axial direction of the impeller as it goes toward an outer side in a radial direction of the impeller, and
in a cross-section along a rotation axis of the impeller, when a center line of the diffuser channel is A, a straight line orthogonal to the center line A at an outlet of the diffuser channel is B, and an angle between the axial direction and the straight line B is α, α≤60° is satisfied.

2. The centrifugal compressor according to claim 1, wherein
α≤40° is satisfied.

3. A centrifugal compressor comprising an impeller and a casing,
the casing including:
a scroll portion that forms a scroll channel on an outer circumferential side of the impeller; and
a diffuser portion that forms a diffuser channel that supplies compressed air compressed by the impeller to the scroll channel, wherein
the diffuser channel includes a curved channel portion that bends toward a front side in an axial direction of the impeller as it goes toward an outer side in a radial direction of the impeller, and
when a minimum value of a distance between a cross-sectional center of the scroll channel and a rotation axis of the impeller is Hmin, and a distance between an outlet of the diffuser channel and the rotation axis is R, Hmin≥0.9R is satisfied.

4. A centrifugal compressor comprising an impeller and a casing,
the casing including:
a scroll portion that forms a scroll channel on an outer circumferential side of the impeller; and
a diffuser portion that forms a diffuser channel that supplies compressed air compressed by the impeller to the scroll channel, wherein
the diffuser channel includes a curved channel portion that bends toward a front side in an axial direction of the impeller as it goes toward an outer side in a radial direction of the impeller, and
in a cross-section along a rotation axis of the impeller, a channel wall surface that forms the curved channel portion includes a curved portion whose curvature increases as it goes toward an outer side in a radial direction of the impeller.

5. The centrifugal compressor according to claim 4, wherein
the curved portion includes a first arc portion having a first curvature and a second arc portion located on an outer side of the first arc portion in the radial direction and having a second curvature larger than the first curvature.

6. The centrifugal compressor according to claim 4, wherein
the curved portion has the curvature that continuously increases as it goes toward an outer side in the radial direction.

7. The centrifugal compressor according to claim 1, wherein
when the minimum value of the distance between the cross-sectional center of the scroll channel and the rotation axis is and the distance between the outlet of the diffuser channel and the rotation axis is R, Hmin≥0.9R is satisfied.

8. The centrifugal compressor according to claim 1, wherein
in the cross-section along the rotation axis of the impeller, a channel wall surface that forms the curved channel portion includes a curved portion whose curvature increases as it goes toward an outer side in the radial direction.

9. The centrifugal compressor according to claim 8, wherein
the curved portion includes a first arc portion having a first curvature and a second arc portion located on an outer side of the first arc portion in the radial direction and having a second curvature larger than the first curvature.

10. The centrifugal compressor according to claim 8, wherein
the curved portion has a curvature that continuously increases as it goes toward an outer side in the radial direction.

11. The centrifugal compressor according to claim 1, wherein
the curved channel portion includes a widened channel width portion in which a channel width is widened as it goes toward an outer side in the radial direction.

12. The centrifugal compressor according to claim 1, wherein
the curved channel portion includes a reduced channel width portion in which the channel width is reduced as it goes toward an outer side in the radial direction.

13. The centrifugal compressor according to claim 1, wherein
in the cross-section along the rotation axis of the impeller, when a frontmost position in the axial direction among the positions on the center line of the diffuser channel is P1,
a rearmost position in the axial direction is P2,
an outermost position in the radial direction is
an innermost position in the radial direction is P4,
a distance between the position P1 and the position P2 in the axial direction is ΔZ, and
a distance between the position P3 and the position P4 in the radial direction is ΔR, ΔZ/ΔR≤0.6 is satisfied.

14. The centrifugal compressor according to claim 1, wherein
in the cross-section along the rotation axis of the impeller, the curved channel portion occupies a range of 30% or more of a presence range of the diffuser channel in the radial direction.

15. The centrifugal compressor according to claim 1, further comprising:
a compressor cover including at least a portion of the scroll portion and a back cover connected to the compressor cover to form the diffuser channel between the compressor cover and the back cover, wherein
a distance between an inner end in the radial direction of a connection portion between the compressor cover and the back cover and the rotation axis of the impeller is larger than the distance between the outlet of the diffuser channel and the rotation axis of the impeller.

16. A turbocharger including the centrifugal compressor according to claim 1.
